(19) United States
(12) Patent Application Publication
(10) Pub. No.: US 2012/0190015 A1
(43) Pub. Date: Jul. 26, 2012

(54) METHOD FOR DETERMINING THE PRESENCE AND CONCENTRATION OF ANALYTES USING A NUCLEIC ACID LIGAND AND RARE EARTH ELEMENTS

(76) Inventors: Jorge Andres Cruz-Aguado, London (CA); Gregory Allen Penner, London (CA)

(21) Appl. No.: 13/388,320

(22) PCT Filed: Jul. 23, 2010
(86) PCT No.: PCT/CA2010/001152

§ 371 Date: Apr. 12, 2012

(30) Foreign Application Priority Data
Aug. 1, 2009 (US) 61230701

(51) Int. Cl. G01N 21/64

(52) U.S. Cl. 435/6.1; 436/501

(57) ABSTRACT

The present invention relates to methods and an apparatus for determining the presence and concentration of an analyte in a sample and the binding of the analyte to a nucleic acid ligand that include measuring the fluorescence emitted by a rare earth element, i.e., terbium, in the presence of the analyte and the nucleic acid ligand. Specific embodiments include the use of terbium and nucleic acid ligands that specifically bind the mycotoxin ochratoxin. A, to detect and quantify ochratoxin A in, for example, food samples such as grain, wine, or beer. The detection of thrombin using terbium and a thrombin-specific nucleic acid ligand is also disclosed. The present invention also relates to a composition comprising a rare earth element as a cation that facilitates the binding of an analyte to a nucleic acid ligand of the analyte.

### FIELD OF THE INVENTION

The present invention relates to methods and apparatuses for determining the presence and concentration of analytes in samples and the binding of the analytes to nucleic acid ligands.

### BACKGROUND OF THE INVENTION

Many oligonucleotide ligands have been identified that bind to molecular targets with high specificity and affinity. The interaction between the oligonucleotide ligand and the molecular target is generally thought to be mediated through the presence of cations, with magnesium being used predominantly. Other cations have been used, however including calcium (Cruz-Aguado and Penner, J. Agric. Food Chem., (2008), 56 (22):10456-10461). The interaction of any given cation with an oligonucleotide and/or with a molecular target is governed by the charges exhibited by the molecules and the physical constraints implicit in the complex between the oligonucleotide and the target molecule. The cations used by others to enhance binding between oligonucleotides and target molecules were not to the knowledge of the inventors fluorescent. The binding of such cations as cofactors of the oligonucleotide/target interaction has not been previously used as a method of determining the occurrence of binding.

Terbium is a rare earth element, discovered in 1843 by the Swedish chemist Carl Gustaf Mosander. It has an atomic weight of 158.92535 daltons, and is strongly fluorescent. Terbium excites at a wavelength of 375 with emission peaks at 485, 545, and 589. The use of rare earth element fluorescence as a means of detecting probe/analyte interactions has been suggested by others (Richardson, Chem. Rev. 82, 541 (1982); Hemmila et al., Bioanalytical Applications of Labelling Technologies. Wallac Oy, Turku, (1995); Yang et al., Chem. Pap. 59 (1) 17-20 (2005)).

Vazquez et al. (Journal of Chromatography A, 727, (2) 185-193 (1996)) demonstrated that the interaction of terbium with the mycotoxin ochratoxin A (hereinafter OTA) could be determined by measuring the enhancement in the fluorescence of terbium when the two molecules interacted. This study, however, did not involve any specificity on the part of the terbium/target interaction and required the purification of OTA to enable analysis.

A key constraint to the measurement of analytes in any sample material is the interaction of the background material with the detection measurement. To one trained in the art, this is referred to as matrix effects, wherein the background material is referred to as the matrix that contains the analyte of interest. Fluorescence as a detection measurement has an advantage over color based assays as the level of sensitivity of analyte detection is higher with fluorescence in the absence of matrix effects. Many matrices however contain fluorescent molecules that may vary in intensity from sample to sample. The rare earth elements that are the subject of this invention exhibit fluorescence over a relatively long time period, hundreds of micro seconds, as opposed to the short fluorescence bursts exhibited by many contaminants within sample matrices. As such, it may be possible to excite a rare earth element and measure emitted light after a lag period measured on an order of microseconds. This phenomenon, known as time resolved fluorescence, is known to one trained in the art. In aspects the present invention this phenomenon may be applied to the methods of the present invention to reduce the negative effect of contaminating fluorescent molecules in sample matrices on the measurement of specific analytes.

There is a need to improve the specificity of the measurement of fluorescence enhancement of rare earth elements to simplify their use as biomarkers. There is also a need to associate the fluorescence enhancement effect of rare earth elements with the concentration of analytes, with variation in nucleic acid sequences, and with the capacity of nucleic acid structures to bind to analytes.

### SUMMARY OF THE INVENTION

The present invention describes methods for achieving measurements based on the fluorescence of rare earth elements and the use of the rare earth elements as a means of detecting analytes in samples, the binding of analytes to nucleic acid ligands and the concentration of analytes in samples. The methods of the present invention can be applied to time course analyses, competition assays, and concentrations. This invention has utility as a diagnostic for many pathological conditions, as well as a useful screening tool for drug discovery.

In one aspect the present invention provides for a method of determining the presence of an analyte of interest in a sample, characterized in that said method comprises: (a) measuring fluorescence emitted by a rare earth element in the presence of the nucleic acid ligand and the sample, said nucleic acid ligand being capable of binding the analyte of interest; and (b) determining the presence of the analyte of interest in the sample based on the fluorescence emitted by the rare earth element.

In another aspect the present invention provides for a method of determining the binding of an aptamer to a target of the aptamer, characterized in that said method comprises: (a) measuring the fluorescence emitted by a rare earth element in the presence of the aptamer and the target; and (b) determining the binding of the aptamer to the target based on the fluorescence emitted by the rare earth element.

In yet another aspect, the present invention provides for a method of determining the concentration of an analyte of interest in a sample, characterized in that said method comprises: (a) measuring the fluorescence emitted by a rare earth element in the presence of the sample and a nucleic acid ligand capable of binding said analyte of interest; and (b) determining the concentration of the analyte of interest in the sample based on the fluorescence emitted by the rare earth element.

In another aspect the present invention provides for a composition for facilitating the binding of an analyte to a nucleic acid ligand of said analyte, characterized in that said comprises a rare earth element.

In another aspect the present invention provides for a use of the composition comprising a rare earth element to determine the presence or concentration of an analyte of interest in a sample, characterized in that said use comprises: (a) contacting the composition with the nucleic acid ligand and the sample; and (b) determining the presence or concentration of the analyte of interest in the sample based on the fluorescence emitted by the rare earth element.

In another aspect the present invention provides for a use of a composition comprising a rare earth element to determine the binding of an analyte of interest to a nucleic acid ligand of said analyte, characterized in that said use comprises: (a) contacting the composition with the nucleic acid ligand and the analyte of interest; and (b) determining the binding of the analyte of interest to the nucleic acid ligand based on the fluorescence emitted by the rare earth element.

In another aspect yet, the present invention provides for a method of determining the presence, binding or concentration of an analyte of interest in a sample solution, characterized in that said method comprises: (a) immobilizing a nucleic acid ligand to a site on a solid carrier strip, said solid carrier strip being in contact at one end to the sample solution and another end in contact with an absorbent pad; (b) allowing the sample solution to flow through the site; (c) contacting the site with a rare earth element; (d) measuring the fluorescence emitted by the rare earth element from the site; and (e) determining the presence, binding or concentration of the analyte of interest in the sample based on the fluorescence emitted by the rare earth element from the site.

In a further aspect yet, the present invention provides for an apparatus for detection of an analyte in a sample solution characterized in that said apparatus comprises: (a) a structure comprising a top surface, said structure configured for supporting a plurality of solid carrier strips below the top surface of the structure; (b) a plurality of loading wells located within the structure, said plurality of loading wells being capable of holding the sample solution and each of said plurality of loading wells configured for keeping one end of the solid carrier strips in contact with the sample; and (c) one or more absorbent pads for contacting the other end of the solid carrier strips.

Advantages of the present invention include at least:

(a) The use of a rare earth element capable of fluorescence as cofactors for the oligonucleotide/target interaction in methods of determining the occurrence of binding;

(b) The ability to detect the presence of an analyte in a sample solution where the sample solution contains contaminating molecules that are not the analyte that fluoresce at or near the same wavelengths as the analyte of interest through the use of time resolved fluorescence of a rare earth element;

(c) The ability to sensitively determine the quantity of an analyte present in a sample solution through comparison of the time resolved fluorescence measurements of a rare earth element of sample material with that of material where the analyte concentration is known;

(d) An apparatus that can be used for high throughput analysis of one or more than one analytes in a sample solution, or different analytes within one or more sample solutions.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 illustrates the interaction of a rare earth element with a nucleic acid;

FIG. 2 illustrates fluorescence response of various oligonucleotides with terbium;

FIG. 3 illustrates a competition assay between OTA1.12.2 (SEQ ID NO: 2) and OTA1.12.6 (SEQ ID NO: 6) in the presence of 5 μM terbium;

FIG. 4 illustrates the effect of thrombin and thrombin aptamer on terbium fluorescence;

FIG. 5 illustrates the effect of varying concentrations of thrombin on DNA-based terbium fluorescence enhancement;

FIG. 6 illustrates a fluorescence spectrum of terbium in the presence of DNA ligands and ochratoxin A (OTA);

FIG. 7 illustrates a comparison of terbium fluorescence in the presence and absence of OTA with different oligonucleotides;

FIG. 8 illustrates a comparison of terbium fluorescence measurements in the presence of OTA, ochratoxin B (OTB), warfarin, OTA/OTA 1.12.2 (SEQ ID NO: 2), OTB/OTA1.12.2 (SEQ ID NO: 2) and warfarin/OTA1.12.2 (SEQ ID NO: 2); and

FIG. 9 illustrates titration analysis of OTA concentration with enhancement of terbium fluorescence.

FIG. 10 A illustrates a side view of a multiple lateral flow strip apparatus in accordance to one embodiment of the present invention.

FIG. 10 B illustrates a top view of a multiple lateral flow strip apparatus in accordance to one embodiment of the present invention;

FIG. 11 A determination of OTA concentration in sample wine solutions in accordance to one aspect of the present invention with the use of an apparatus in accordance with one embodiment of the present invention, single point, excitation 375 nm, emission 545 nm;

FIG. 11 B determination of OTA concentration in sample wine solutions in accordance to one aspect of the present invention with the use of an apparatus in accordance with one embodiment of the present invention, integrated area, excitation 340 to 400 nm, emission 545 nm;

FIG. 12 A determination of OTA concentration in beer samples in accordance to one aspect of the present invention with the use of an apparatus in accordance with one embodiment of the present invention with a DNA ligand immobilized on a lateral flow strip; and

FIG. 12 B determination of OTA concentration in grain samples in accordance to one aspect of the present invention with the use of an apparatus in accordance with one embodiment of the present invention with a DNA ligand immobilized on a lateral flow strip.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE INVENTION

### 1. Definitions

Non-limiting terms are not to be construed as limiting unless expressly stated or the context clearly indicates otherwise (for example “including”, “having” and “comprising” typically indicate “including without limitation”). Unless indicated otherwise, except within the claims, the use of “or” includes “and” and vice-versa. Singular forms included in the claims such as “a”, “an” and “the” include the plural reference unless expressly stated otherwise.

For convenience, the meaning of certain terms and phrases employed in the specification, examples, and appended claims are provided below. Unless defined otherwise, all technical and scientific terms used herein have the same meaning as commonly understood by one of ordinary skill in the art to which this invention belongs.

The term “effective amount” as used herein means an amount effective and at concentrations and for periods of time necessary to achieve a desired result.

The term “rare earth element” include the chemical elements Lanthanum, Cerium, Praseodymium, Neodymium, Promethium, Samarium, Europium, Gadolinium, Terbium, Dysprosium, Holmium, Erbium, Thulium, Ytterbium, and Lutetium.

The term “ligand” or “aptamer” means an oligonucleotide that binds another molecule or target analyte. In a population of candidate oligonucleotides, a ligand or aptamer is one which binds with greater affinity than that of the bulk population. In a candidate mixture there can exist more than one ligand or aptamer for a given target. The ligands or aptamers may differ from one another in their binding affinities for the target molecule.

The term “nucleic acid” means either DNA, RNA, single-stranded or double-stranded and any chemical modifications thereof.

The term “oligonucleotide” as used herein means a short nucleic acid polymer. Typically an oligonucleotide includes twenty or fewer bases. Oligonucleotides with more than twenty bases are also included in this definition.

The term “sample” as used herein include biological samples such as animal (including human) and plant samples. Plant samples include agricultural samples, including wine samples.

### 2. Overview

The inventors discovered that the need for a cation to mediate the binding between a nucleic acid ligand and an analyte may be satisfied by a rare earth element, including terbium. This may represent an advancement in the use of fluorescence to determine the amount of binding of a nucleic acid ligand over previous methods in that it may facilitate the use of time resolved fluorescence. This approach may maintain the strength of the signal associated with target analyte binding while decreasing the background. As such the present invention may have utility as practical means of using nucleic acid ligands in diagnostic platforms for target analytes in sample matrices.

This invention provides methods and compositions that combines the use of a ligand with terbium for the specific identification of analytes, including mycotoxins, toxins, drugs, proteins, peptides, nucleic acids, inorganic compounds, food additives or nutritive compounds. Moreover, this invention provides methods and compositions for the detection and measuring concentration of analytes from a range of sample matrices including but not limited to beer, wine, and grain extracts.

The invention will be explained in details by referring to the figures.

### 3. Use of Rare Earth Elements as Cation Bridge

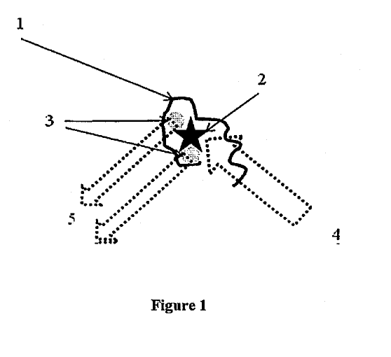

The inventors have discovered that rare earth elements may act as the necessary cation bridge between a nucleic acid ligand and an analyte. As illustrated in FIG. 1 the fluorescence of a rare earth element 3 may be enhanced by acting as a cation bridge as the implicit physical proximity of the relationship rare earth element 3/nucleic acid ligand 1/analyte 2 reduces the negative effect of water molecules on rare earth element 1 fluorescence. The physical proximity of the relationship facilitates a transfer of energy from the bound analyte 2 (such as the energy transmitted by excitation of the analyte 2 at a specific wavelength of light 4) to the rare earth element 3 where such energy is then released at the emission wavelength 5 of the rare earth element.

As such, in one aspect, the present invention provides for compositions comprising rare earth elements that may facilitate the binding of an analyte to a nucleic acid ligand of the analyte.

### 4. Determining the Presence of Target Analytes in a Sample

In another aspect the present invention provides for a method of determining the presence of an analyte of interest in a sample. The method may comprise at least the following steps: (a) measuring fluorescence emitted by a rare earth element in the presence of the nucleic acid ligand and the sample, said nucleic acid ligand being capable of binding the analyte of interest; and (b) determining the presence of the analyte of interest in the sample based on the fluorescence emitted by the rare earth element.

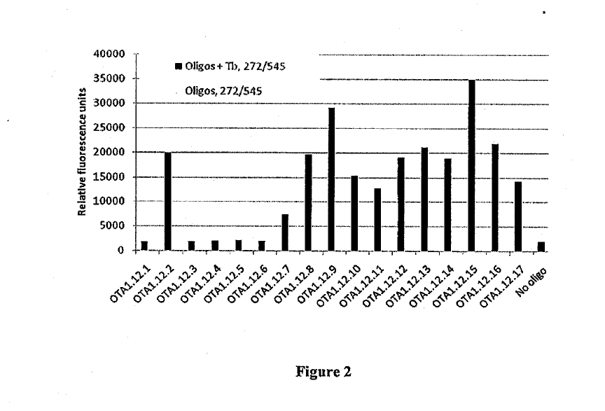

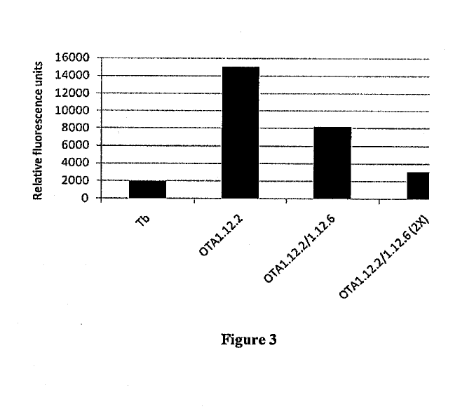

As shown in FIG. 2 the inventors demonstrated that certain oligonucleotides listed in Table 1 may be capable of enhancing the fluorescence of the rare earth element terbium when excited at a wavelength known to excite the oligonucleotides. FIG. 3 shows that this enhancement in fluorescence is not strictly related to terbium binding to the oligonucleoties. FIG. 3 provides an exhibition of a competitive assay demonstrating that oligonucleotides with which terbium does not exhibit an enhanced fluorescence, still bind terbium. The addition of such oligonucleotides to a solution containing oligonucleotides that do enhance the fluorescence of terbium results in a decrease of their terbium fluorescence enhancement.

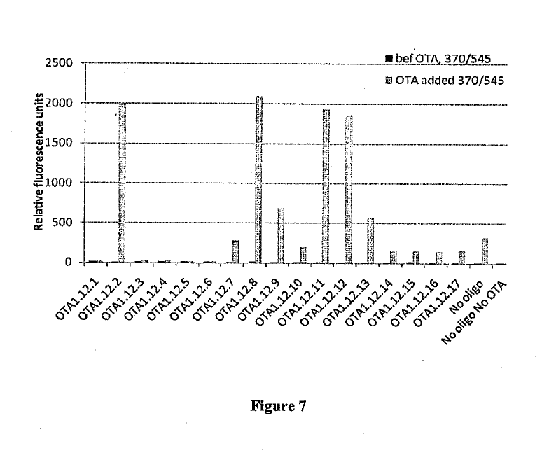

Table 1 illustrates that some of the oligonucleotides are ochratoxin A (OTA) ligands, that is they are capable of binding the mycotoxin OTA. As shown in FIG. 7, the inventors demonstrated that the majority of the OTA aptamers listed in Table 1 may be capable of enhancing the fluorescence of the rare earth element terbium in the presence of OTA (the target analyte of these OTA aptamers) when the mixture OTA/aptamer/terbium is excited at a wavelengths known to excite OTA.

In another aspect, the present invention provides for a method of determining the binding of a nucleic acid ligand to its target analyte. The method may comprise at least the following steps: (a) measuring the fluorescence emitted by a rare earth element in the presence of the aptamer and the target; and (b) determining the binding of the aptamer to the target based on the fluorescence emitted by the rare earth element.

FIG. 7 illustrates that the fluorescence emitted by terbium may be enhanced when the fluorescence emitted by terbium is measured in the presence of an aptamer and its target (OTA).

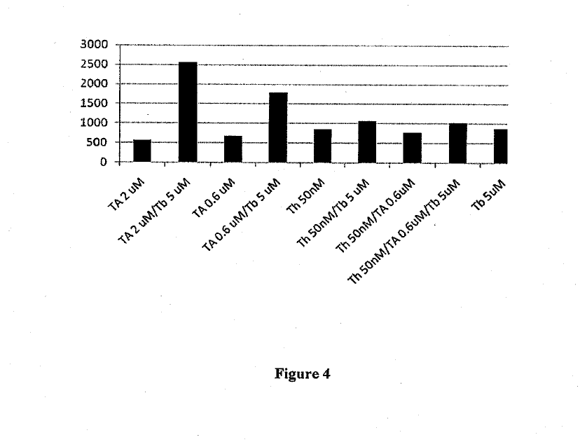

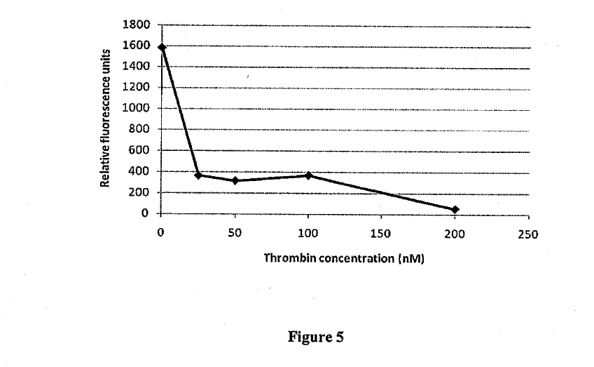

ARC183 (SEQ ID NO: 18) is a known aptamer of the protein thrombin. As illustrated in FIG. 4 ARC 183 (SEQ ID NO: 18) enhances the fluorescence of terbium. The inventors discovered that in the presence of thrombin, the target analyte of ARC183 (SEQ ID NO: 18), the enhanced effect of ARC183 (SEQ ID NO: 18) in the fluorescence of terbium disappears.

As such, in one aspect of the present invention, the fluorescence emitted by terbium may be used to determine whether a ligand may be bound to its target.

### 5. Determining Target Analyte Concentration

In another aspect, the methods of the present invention may permit accurate measurement of concentrations of target analytes in aqueous samples. As such, in another aspect, the present invention provides for a method of determining the concentration of an analyte of interest in a sample, characterized in that said method comprises: (a) measuring the fluorescence emitted by a rare earth element in the presence of the sample and a nucleic acid ligand capable of binding said analyte of interest; and (b) determining the concentration of the analyte of interest in the sample based on the fluorescence emitted by the rare earth element.

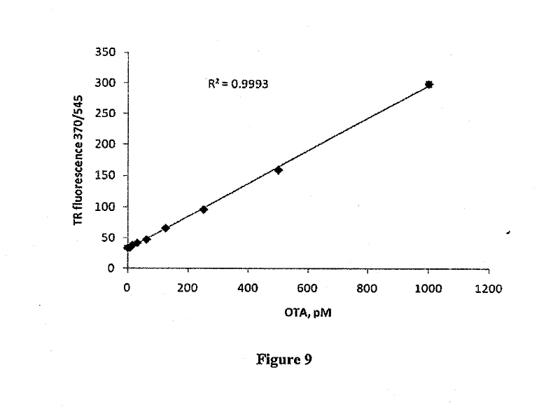

The inventors used titration analyses to demonstrate that terbium fluorescence may be used to determine the concentration of an analyte of interest in a sample. FIG. 9 shows the linear dependence of the fluorescent activity of terbium in the presence of increasing concentrations of the analyte ochratoxin A (OTA). The sensitivity of this concentration test for OTA is as low as 50 pM, a level that is well below regulatory requirements for the presence of this mycotoxin in food material, which may be from about 2 to about 5 ppb and as low as about 0.5 ppb in baby food. A 2.476 nM concentration of OTA is equivalent to 1 ppb, most regulatory requirements for the maximum concentration of OTA in foods or beverages globally stipulate that levels must be below 5 ppb.

### 6. Determining Analyte Concentration with the Use of Terbium and an Immobilized Ligand

The inventors found that the addition of the rare earth element and nucleic acid ligand to a sample matrix such as a grain extract, or wine may lead to a loss of satisfactory resolution. Presumably this loss of resolution may be due to the binding of the rare earth element to compounds within the sample matrix, thus reducing the binding of terbium to the analyte of interest. Therefore, the evaluation of samples in accordance with the methods described above may be carried out where the analyte of interest has been previously purified from the sample through a method known in the art including but not limited to an immuno or nucleic acid based affinity column. The use of the rare earth element terbium in a complex where background matrix effects are not a consideration results in a significant increase in the sensitivity of measurements. The use of a DNA ligand in this case represents an improvement over prior art, as the signal from the rare earth element in the presence of the ligand may be stronger than if the earth element was simply binding to the target analyte of said ligand. Presumably this may be due to the evacuation of water from the physical proximity of the terbium molecule while it is associated with the target analyte of said ligand.

One method of reducing binding competition for the rare earth element from contaminating molecules in sample matrices may be by immobilizing the ligand and allow the sample to flow through an immobilized ligand.

Through the use of a lateral flow device the inventors immobilized a DNA ligand a specific spot on a solid carrier strip such as cellulose or nitrocellulose or nylon. One end of the strip may be immersed in a sample solution well, while the other end of the strip may be placed in physical contact with an absorbant pad. A solution that may contain the analyte may be added to the sample solution well and may be allowed to wick through the solid carrier strip onto the absorbant pad. Once all the sample solution has passed through the site where the DNA ligand is immobilized a solution containing terbium may added. A preferred embodiment is to add the terbium solution directly onto the site where the DNA ligand has been immobilized or affixed. The site or spot may then be read immediately in a fluorescent reader with an excitation wavelength that excites the desired analyte, and the emission wavelength of the rare earth element used. In the case of ochratoxin A and terbium, the excitation wavelength used may be 375 nm, and the emission wavelength measured may be 485 nm, 545 nm or 589 nm.

In one aspect, the present invention provides for a method of determining the presence, binding or concentration of an analyte of interest in a sample solution, said method may comprise at least the following steps: (a) immobilizing a nucleic acid ligand to a site on a solid carrier strip, said solid carrier strip being in contact at one end to the sample solution and another end in contact with an absorbent pad; (b) allowing the sample solution to flow through the site; (c) contacting the site with a rare earth element; (d) measuring the fluorescence emitted by the rare earth element from the site; and (e) determining the presence, binding or concentration of the analyte of interest in the sample based on the fluorescence emitted by the rare earth element from the site.

In aspects, this invention provides a means of applying the time resolved fluorescence phenomenon to reduce the negative effect of contaminating fluorescent molecules in sample matrices on the measurement of specific analytes.

### 7. Analytical Apparatus

In another aspect, the present invention provides an apparatus whereby multiple test strips may be held by a single platform. This apparatus enables a method whereby samples may be added to a loading well of each individual strip. The samples may be allowed to flow through the strips simultaneously and all strips may then be analyzed for the amount of analyte present in each sample concurrently in existing microtitre plate reading machines. Alternatively, a subset of the strips down to one strip at a time may be processed in the same device. It would be clear to one trained in the art that this approach may provide higher throughput capacity for analysis, while at the same time decreasing experimental error. It would also be clear to one trained in the art that this apparatus and method may be broadly applicable to all analytes/ligand interactions. The methods of the present invention may also be carried out using the novel apparatus described herein.

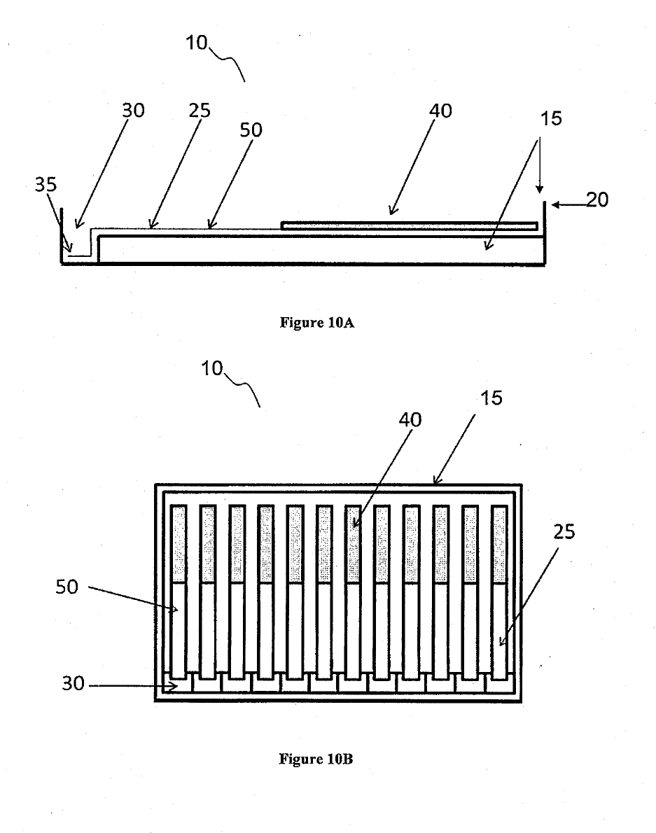

As illustrated in FIGS. 10 A and 10 B, the apparatus 10 of the present invention may comprise a structure 15 comprising an upper or top edge 20. The structure 15 may be configured for supporting a plurality of solid carrier strips 25 below the top edge 20 of the structure 15. The apparatus 10 may be constructed in such a way that the solid carrier strip 25 is below the upper edge 20 of the structure. The structure 15 may include a plurality of sample or loading wells 30 for holding samples 35. The apparatus 10 may also include one or more absorbent pads 40. The carrier strip 25 (or strips if more than one is provided) may have one end within a loading well 30, which may contain the sample solution 35 under study. The other end of the solid carrier strip 25 may be in contact with an absorbing pad 40. A capture probe 50 capable of binding to the target analyte, may be affixed to the carrier strip 25 between the two ends of the carrier strip 25. The apparatus 10 may be useful for the fluorometric-based methods of the present application, including the detection of an analyte in a sample solution and for determining the concentration of the analyte in the sample using the terbium-based fluorometric methods of the present invention. In one aspect of the present invention a kit comprising the apparatus 10, one or more absorbent pads and a plurality of solid carrier strips is provided. In another aspect of the present invention the kit may further comprise a composition comprising a rare earth element, and/or a capture probe 50.

In one embodiment, the apparatus may include a plurality of wells.

The solid carrier strips 25 may be composed of cellulose, nitrocellulose and/or nylon.

The capture probes that may be used with the apparatus 10 may include any ligand capable of binding to the analyte of interest, including aptamers, antibodies, enzymes and/or any combinations thereof.

The analyte may include mycotoxins, toxins, drugs, proteins, peptides, oligonucleotides, inorganic compounds, food additives, or a nutritive compound.

A single structure may be capable of accommodating a plurality of carrier strips. As such, the apparatus of the present invention may be used in high throughput analyses.

The apparatus of the present invention may be capable of being used in a method whereby one or more samples having unknown concentration of analyte of interest may be added to different loading wells in the structure. Taking the apparatus 10 of FIGS. 10 A and 10 B as an example, one end of the solid carrier strips 25 may be immersed in the loading wells 30 having the sample solution 35, while the other end of the strips 25 may be in contact with the absorbing pad 40. An appropriate capture probe 50 may be affixed to each of the carrier strips 25 (the probe area). An adequate time (from about 2 to about 30 minutes, however more than about 2 minutes or less than about 30 minutes may be necessary) may be allowed for the sample solution to pass through the probe area. In this enablement, the method of detection of the analyte is through the addition of a terbium solution on the site of the immobilized DNA ligand followed by measurements in a fluorometer. This enablement allows for the measurement of multiple test strips simultaneously with existing microtitre plate capable fluorescent readers that are currently commercially available.

Embodiments of the invention are described by reference to the following specific examples which are not to be construed as limiting.

### EXAMPLES

### Example 1

### Use of Terbium Fluorescence for Determining Nucleic Acid Ligand/Target Analyte Binding

### Materials and Methods

The inventors had previously discovered a DNA ligand that bound specifically and with high affinity to ochratoxin A (OTA; Cruz-Aguado and Penner, J. Agric. Food Chem., (2008), 56 (22):10456-10461, the content of which is incorporated herein by reference) referred to herein as OTA1.12. The inventors reduced this sequence to a shorter version which appeared to bind with even higher affinity referred to herein as OTA1.12.2 (SEQ ID NO: 2). A number of other oligonucleotides with varying but similar sequences were also designed and synthesized (Table 1).

Each of the oligonucleotides listed in the first column of Table 1 were combined at a concentration of 3 μM with 5 μM terbium chloride in a Binding Buffer composed of 10 mM Tris/HCl (pH 7.0), 120 mM NaCl, 5 mM KCl, and 0.5 mM CaCl2. The solutions were exposed to a range of excitation wavelengths from 230 to 400 nm, and fluorescence emission from terbium was measured at 545 nm.

### Results

As shown in FIG. 2 in the absence of terbium, no oligonucleotide exhibited significant emission of fluorescence at 545 nm. Terbium in association with certain oligonucleotides exhibited an enhanced fluorescence response.

The inventors next assessed the affinity for the mycotoxin ochratoxin A (OTA) of each of the oligonucleotides listed in Table 1. Table 1 illustrates the relationship between OTA binding and terbium fluorescence of oligonucleotide.

TABLE 1

| Oligonucleotides | Kd (μM) | Tb fluorescence | |
|---|---|---|---|
| OTA1.12.1.1 | NB | 1715 | SEQ ID NO: 1 |
| OTA1.12.2 | 0.2 | 19945 | SEQ ID NO: 2 |
| OTA1.12.3 | NB | 1939 | SEQ ID NO: 3 |
| OTA1.12.4 | NB | 2015 | SEQ ID NO: 4 |
| OTA1.12.5 | 0.8 | 2115 | SEQ ID NO: 5 |
| OTA1.12.6 | NB | 2017 | SEQ ID NO: 6 |
| OTA1.12.7 | NB | 7367 | SEQ ID NO: 7 |
| OTA1.12.8 | 0.2 | 19731 | SEQ ID NO: 8 |
| OTA1.12.9 | 1.6 | 29271 | SEQ ID NO: 9 |
| OTA1.12.10 | NB | 15392 | SEQ ID NO: 10 |
| OTA1.12.11 | 0.4 | 12804 | SEQ ID NO: 10 |
| OTA1.12.12 | 0.5 | 19082 | SEQ ID NO: 12 |
| OTA1.12.13 | NB | 21187 | SEQ ID NO: 13 |
| OTA1.12.14 | NB | 18908 | SEQ ID NO: 14 |
| OTA1.12.15 | NB | 34907 | SEQ ID NO: 15 |
| OTA1.12.16 | NB | 21916 | SEQ ID NO: 16 |
| OTA1.12.17 | NB | 14288 | SEQ ID NO: 17 |
| No oligo | | 1964 | |

With the exception of SEQ ID NO: 5, those oligonucleotides that exhibit binding to OTA are also able to enhance the fluorescence of terbium. Accordingly, terbium in combination with any of SEQ ID NOs.: 2, 8, 9, 11 or 12, for example, may be used to detect the presence of OTA in a sample and to detect binding of OTA to the respective ligand.

### Example 2

### Test of Terbium Fluorescence Enhancement with an Oligonucleotide Known to Bind Thrombin

Macaya et al., (PNAS April 15, (1993) 90 (8):3745-3749) used two-dimensional 1H NMR spectroscopy to demonstrate that a DNA ligand (ARC183, GGTTGGTGTGGTTGG (SEQ ID NO: 18) for the protein thrombin) formed a G-quartet structure in solution. The inventors of this present invention tested the potential of the DNA Ligand ARC183 (SEQ ID NO: 18) for the protein thrombin for terbium fluorescence both in the presence and absence of thrombin. Combinations of thrombin, thrombin DNA ligand, and terbium were excited over a range of wavelengths with emission measured at 545. A clear excitation peak was exhibited at 272 nm.

The effect of thrombin and thrombin DNA ligand on terbium fluorescence is illustrated in FIG. 4. The combination of 2 μM thrombin DNA ligand with terbium exhibited the strongest enhancement of terbium fluorescence. Neither terbium by itself, nor the thrombin DNA ligand, nor thrombin exhibited substantial terbium fluorescence enhancement.

Next, thrombin concentration was titrated with 5 μM terbium and 2 μM thrombin DNA ligand, the mixtures were then excited at 272 nm and emission measured at 545 nm. FIG. 4 illustrates the effect of varying concentrations of thrombin on DNA based terbium fluorescence enhancement.

It would appear that thrombin is acting on the DNA ligand to cause an irreversible change that prevents the ligand from enhancing terbium fluorescence. A concentration of 25 nM thrombin combined with 2 μM DNA ligand represents a 1:80 ratio of thrombin protein to thrombin DNA ligand. The thrombin DNA ligand is believed to bind in a 1:1 ratio to thrombin, meaning that with a 1:80 ratio only 1/80th of the DNA ligands would be expected to be bound to a thrombin molecule.

### Example 3

### The Use of Terbium to Determine the Concentration of an Analyte

Ochratoxin A (OTA) at a concentration of 20 nM was combined with 3 μM OTA1.12.2 (SEQ ID NO: 2) DNA ligand, and 5 μM terbium chloride in a buffer composed of 10 mM Tris/HCl (pH 7.0), 120 mM NaCl, 5 mM KCl, and 0.5 mM CaCl₂. Terbium fluorescence was measured with an excitation wavelength of 370 nm, and an emission wavelength of 545 nm.

### Results

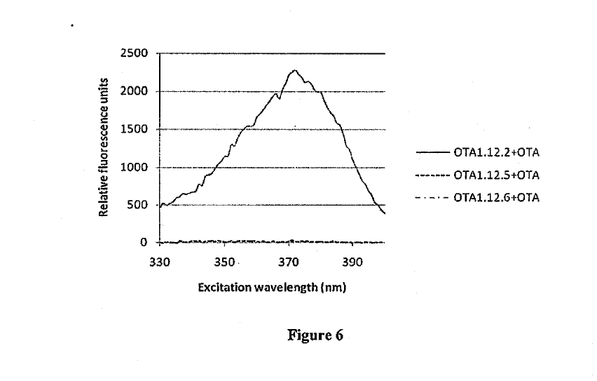

FIG. 6 illustrates the fluorescence spectrum of terbium in the presence of 3 different DNA ligands (OTA 1.12.2, 1.12.6 and 1.12.5; SEQ ID NOs: 2, 5 and 6) and OTA. It is clear to one trained in the art that of these three DNA ligands only OTA 1.12.2 (SEQ ID NO: 2) exhibits the enhanced terbium effect in association with OTA.

In Example 1 above the enhancement of terbium fluorescence in the presence of DNA ligands in the absence of the target that they bound to was demonstrated. This enhanced fluorescence peaked at an excitation wavelength around 272 nm, corresponding to the absorption of light energy by the oligonucleotide. As shown in FIG. 6 in the presence of OTA, however, the excitation peak observed was at 370 nm, corresponding to the expected excitation wavelength of OTA. The oligonucleotides tested in the presence of OTA were also measured at this wavelength (370 nm) and compared to the fluorescence exhibited in the presence of OTA. FIG. 7 illustrates a comparison of terbium fluorescence in the presence and absence of OTA with different oligonucleotides.

The specificity of the combination of DNA ligand plus terbium to detect OTA binding was demonstrated by exposing the DNA ligand, OTA1.12.2 (SEQ ID NO: 2) to other molecules with structural similarity to OTA including ochratoxin B (OTB), and warfarin in the same buffer used in Binding Buffer.

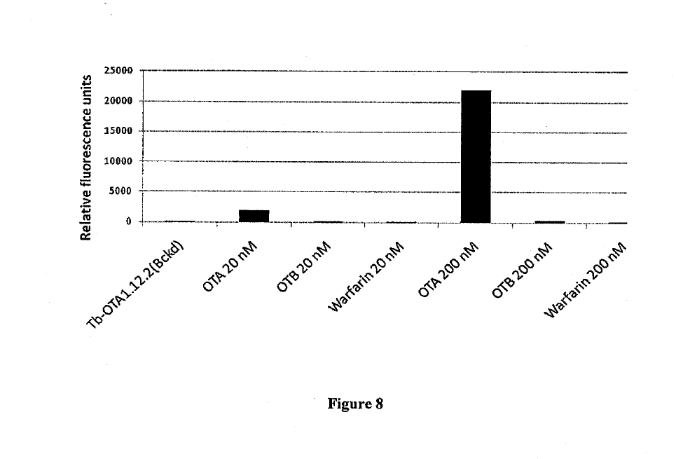

FIG. 8 illustrates the specificity of the use of terbium fluorescence measurements for ochratoxin in combination with an OTA DNA aptamer. Terbium fluorescence in the presence of OTA and the DNA ligand OTA1.12.2 (SEQ ID NO: 2) exhibited sixty times more fluorescence than the same concentration of OTB in the presence of the same DNA ligand. When the OTA concentration was reduced to ten fold less than OTB, the fluorescence measured at an excitation of 370 nm was still five fold higher than 200 nM OTB. Warfarin, a molecule with a similar structure to both OTB and OTA did not induce any measurable fluorescence in terbium in association with the DNA ligand OTA1.12.2 (SEQ ID NO: 2) at an excitation of 370 nm. This demonstrates that the measurement of terbium fluorescence in the presence of a DNA ligand and a target molecule is highly specific to the target molecule in question.

Different concentrations of OTA were tested to determine the sensitivity of the terbium concentration assay.

FIG. 9 illustrates titration analysis of OTA concentration with enhancement of terbium fluorescence. The regression between the observed values and expectations based on a linear relationship between the enhancement of terbium fluorescence and OTA concentration was very high r²=0.9993. The average standard deviation exhibited across data points was less than 2 pM, with no datapoint exhibiting variation greater than 3 pM over replications. The sensitivity of this test OTA is as low as 50 pM, a level that is well below regulatory requirements for the presence of this mycotoxin in food material.

### Example 4

### Concentration of OTA in White Wine, Beer and Grain Extracts

In all solid carrier strip tests the following procedure was followed. Samples of white wine, beer or grain extracts were applied in a volume of 100 μl to a loading well. A total of 100 pmoles of DNA ligand for OTA was applied to each strip and allowed to dry for at least ½ hour before strips were run. Solutions were allowed to wick through the strips for about 30 min, after which they were dried for five min. at 37° C. The area containing the immobilized DNA ligand was cut from the strip and placed in the wells of a low fluorescence microplate. Two μl of a 5 mM TbCl₃ solution was added to each well in the centre of the cut paper, and the fluorescence measured immediately with an excitation at 375 nm, a lag period of 30 μsec, and an emission wavelength of 545.

### White Wine

Strips of Whatman paper 54SCF of 0.35×7 cm and cellulose fiber absorbing pad 2.8 cm² (Millipore CFSP223000) were installed in a modified 384 well solid black microplate. The plate was previously modified to accommodate the paper strip, by reducing the height of the walls under the lateral flow strip. A solution containing the DNA ligand, OTA1.12.2-2X, (SEQ ID NO. 19) in 20% MeOH was loaded on the paper.

Three aliquots of 30 nL of the ligand solution, with air dryings in between the application of each aliquot, were loaded onto the same spot on the test strip for a total quantity of DNA ligand of 13.5 pmol. The strips were allowed to air dry for 30 mins. Then, 100 uL of a solution comprised of a 1:1:2 (v/v/v) mixture of white wine, water, and 2× Running Buffer (10 mM TRIS pH 7.0, NaCl 120 mM, KCl 5 mM, CaCl2 5 mM) containing varying concentrations of ochratoxin A was added to sample wells. The solution was allowed to flow across the strips for 30 mins. prior to evaluation, resulting in complete removal of sample solution from the sample loading wells.

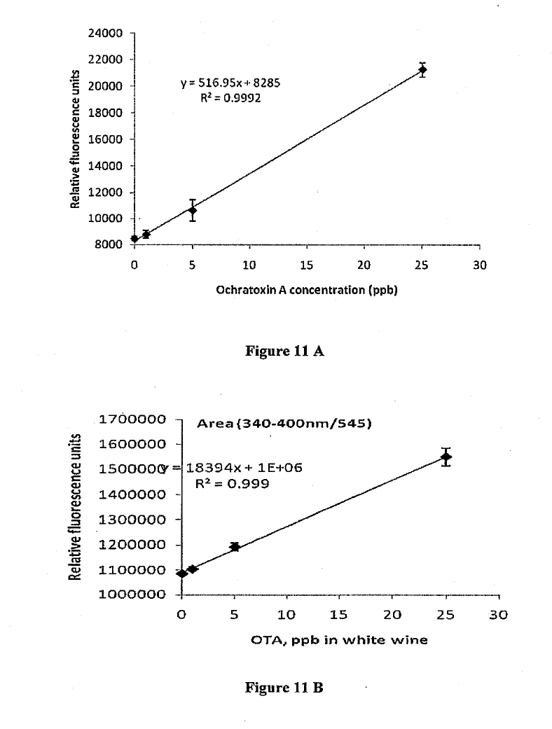

The amount of OTA captured by the immobilized ligand was determined by the addition of 0.5 μL of 5 mM TbCl3 in 10 mM TRIS/HCl buffer (pH 7.0) containing 120 mM NaCl, and 5 mM KCl to the top of the aptamer capture area (wells E in the 384 well microplate). The fluorescence was then measured immediately in a fluorometer (TECAN, Safire II) using an excitation wavelength of 375 nm, and measurement of an emission wavelength of 545 nm, with a 20 nm band pass, and an integration time of 2,000 us. A lag time between excitation and the measurement of emission of 30 us was used. Results from two replicate experiments are disclosed in FIG. 11 A. The fluorescence was also measured based on an excitation scan with wavelengths from 340 to 400 nm with emission at 545 nm. The results are shown in FIG. 11 B. This allows normalizing the data from the fluorescence at 340 nm and correction for positioning errors.

### Beer

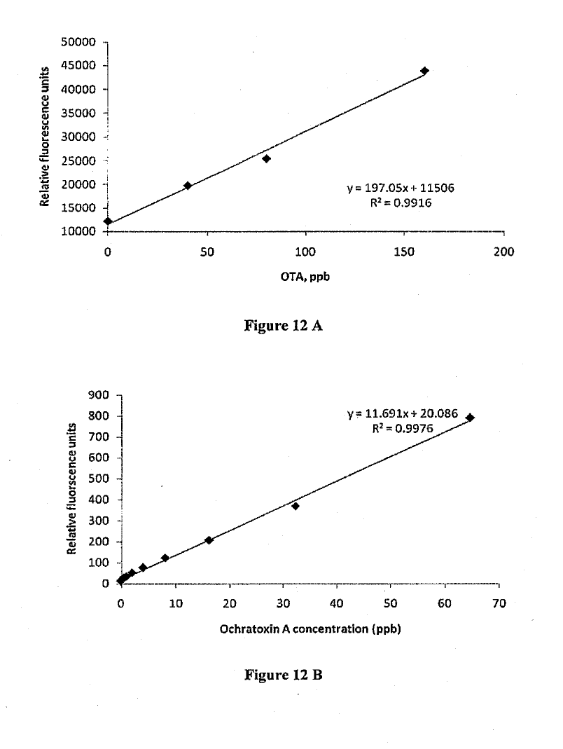

An enablement of the use of the complex among terbium and the DNA ligand for OTA for the determination of OTA concentration in beer was demonstrated through the use of spiked samples of Guinness beer. A can of Guinness beer was purchased and opened on the day of the experiment. Two ml of beer was combined with two ml of water, and four ml of a buffer composed of 240 mM NaCl, 10 mM KCl, and 10 mM CaCl₂. The pH of the solution was adjusted to 7.4 with the addition of four drops of 1 M Tris to the final solution. Measurements were taken as indicated for white wine. The results are shown in FIG. 12 A.

### Crude Grain Extracts

An enablement of the use of the complex between terbium and the DNA ligand for OTA for the determination of OTA concentration in association with grain extracts was demonstrated through the addition of known amounts of OTA to grain extract solutions. A certified reference material sample of OTA was purchased from Sigma that was certified as less than 1 ppb OTA. A 10 g sample of grain was extracted with a 40 ml of 60% methanol solution. The resulting solution is henceforth referred to as “grain extract”. One volume of grain extract was combined with one volume of water and two volumes of the same buffer used for the beer example except that 1 mM CaCl₂ was used instead of 10 mM. The pH of mixed solutions was adjusted to 7.2 with the addition of Tris. The results are shown in FIG. 12 B.

The above disclosure generally describes the present invention. Changes in form and substitution of equivalents are contemplated as circumstances may suggest or render expedient. Although specific terms have been employed herein, such terms are intended in a descriptive sense and not for purposes of limitation. Other variations and modifications of the invention are possible. As such modifications or variations are believed to be within the sphere and scope of the invention as defined by the claims appended hereto.

1-10. (canceled)

11. A method for determining the binding of an analyte of interest to a nucleic acid ligand of the analyte of interest, characterized in that the method comprises:
(a) contacting the analyte of interest and the nucleic acid ligand with a rare earth element to form a mixture;
(b) exposing the mixture to a light wavelength that excites the analyte or the rare earth element; and
(c) determining the binding of the nucleic acid ligand to the analyte of interest based on the fluorescence emitted by the rare earth element.

12-13. (canceled)

14. The method of claim 11 characterized in that said rare earth element is terbium.

15. The method of claim 11 characterized in that said analyte of interest is a mycotoxin, a toxin, a drug, a protein, a peptide, a nucleic acid, an inorganic compound, a food additive or a nutritive compound.

16. The method of claim 11 characterized in that said analyte of interest is ochratoxin A.

17. The method of of claim 16 characterized in that said nucleic acid ligand comprises a nucleic acid sequence of SEQ ID NO: 2.

18-19. (canceled)

20. A method of determining the concentration of an analyte of interest in a sample, characterized in that said method comprises:
(a) purifying the analyte from the sample;
(b) combining the purified analyte with a nucleic acid ligand capable of binding the analyte of interest and a rare earth element to form a mixture,
(c) exposing the mixture to a light wavelength that excites the analyte or the rare earth element,
(d) measuring emission at a wavelength emitted by the rare earth element; and
(e) determining the concentration of the analyte of interest in the sample by comparing the measurement obtained in step (d) with a control representing the relationship between the amount of fluorescence of the rare earth element and known concentrations of the analyte of interest.

21. The method of determining the concentration of an analyte of interest of claim 20 characterized in that said emission is measured after a time delay to reduce contaminating emission from molecules other than the analyte of interest in the sample.

22. (canceled)

23. (canceled)

24. The method of determining the concentration of an analyte of interest of claim 20 characterized in that said rare earth element is terbium.

25. The method of determining the concentration of an analyte of interest of claim 20 characterized in that said analyte is a mycotoxin.

26. The method of determining the concentration of an analyte of interest of claim 20 characterized in that said analyte is ochratoxin A.

27. The method of determining the concentration of an analyte of interest of claim 26 characterized in that said nucleic acid ligand comprises a nucleic acid sequence of SEQ ID NO: 2.

28-46. (canceled)

47. A method for determining the concentration of an analyte in a sample solution, characterized in that the method comprises the following steps:
(a) affixing a DNA ligand of the analyte to a site on a solid carrier;
(b) contacting the solid carrier with the sample solution;
(c) allowing sufficient time for the sample solution to move through the site on the solid carrier,
(d) adding a rare earth element to the site,
(e) exposing the site to a wavelength for the excitation of said analyte,
(f) measuring the fluorescence emitted from the rare earth element at the site, and
(g) determining the concentration of the analyte in the sample by comparing the measurement of step (f) to the measurement of fluorescent emission from the rare earth element in samples having known concentration of the analyte.

48. The method of claim 47 characterized in that the analyte of interest is ochratoxin A and the DNA ligand is a DNA ligand comprising a nucleic acid sequence of SEQ ID NO: 2.

49. The method of claim 11 characterized in that the rare earth element is europium.

50. The method of determining the concentration of an analyte of interest of claim 20 characterized in that the rare earth element is europium.


SEQUENCE LISTING (20 sequences)

SEQ ID NO: 1 - DNA, 41 bp, Artificial Sequence
  Synthetic DNA ligand (OTA1.12.1)
gatcgggtgtgggtggcgtaaagggagcatcggacaacgat

SEQ ID NO: 2 - DNA, 36 bp, Artificial Sequence
  Synthetic DNA ligand (OTA1.12.2)
gatcgggtgtgggtggcgtaaagggagcatcggaca

SEQ ID NO: 3 - DNA, 41 bp, Artificial Sequence
  Synthetic DNA ligand (OTA1.12.3)
gatcgggtgtcggtggcgtaaagggagcatcggacaacgat

SEQ ID NO: 4 - DNA, 41 bp, Artificial Sequence
  Synthetic DNA ligand (OTA1.12.4)
gatcgtgtgtcggtggcgtaaagggagcatcggacaacgat

SEQ ID NO: 5 - DNA, 39 bp, Artificial Sequence
  Synthetic DNA ligand (OTA1.12.5)
gatcgggtgtgggtggcgtaaagggagcatcggacaacg

SEQ ID NO: 6 - DNA, 39 bp, Artificial Sequence
  Synthetic DNA ligand (OTA1.12.6)
gatcgggtgtcggtggcgtaaagggagcatcggacaacg

SEQ ID NO: 7 - DNA, 17 bp, Artificial Sequence
  Synthetic DNA ligand (OTA1.12.7)
agtggcgtaaacggact

SEQ ID NO: 8 - DNA, 33 bp, Artificial Sequence
  Synthetic DNA ligand (OTA1.12.8)
gatcgggtgtgggtggcgtaaagggagcatcgg

SEQ ID NO: 9 - DNA, 30 bp, Artificial Sequence
  Synthetic DNA ligand (OTA1.12.9)
gatcgggtgtgggtggcgtaaagggagcat

SEQ ID NO: 10 - DNA, 27 bp, Artificial Sequence
  Synthetic DNA ligand (OTA1.12.10)
gatcgggtgtgggtggcgtaaagggag

SEQ ID NO: 11 - DNA, 32 bp, Artificial Sequence
  Synthetic DNA ligand (OTA1.12.11)
gatcgggtgtgggtggcgtaaagggagcatcg

SEQ ID NO: 12 - DNA, 31 bp, Artificial Sequence
  Synthetic DNA ligand (OTA1.12.12)
gatcgggtgtgggtggcgtaaagggagcatc

SEQ ID NO: 13 - DNA, 32 bp, Artificial Sequence
  Synthetic DNA ligand (OTA1.12.13)
atcgggtgtgggtggcgtaaagggagcatcgg

SEQ ID NO: 14 - DNA, 31 bp, Artificial Sequence
  Synthetic DNA ligand (OTA1.12.14)
tcgggtgtgggtggcgtaaagggagcatcgg

SEQ ID NO: 15 - DNA, 30 bp, Artificial Sequence
  Synthetic DNA ligand (OTA1.12.15)
cgggtgtgggtggcgtaaagggagcatcgg

SEQ ID NO: 16 - DNA, 29 bp, Artificial Sequence
  Synthetic DNA ligand (OTA1.12.16)
gggtgtgggtggcgtaaagggagcatcgg

SEQ ID NO: 17 - DNA, 28 bp, Artificial Sequence
  Synthetic DNA ligand (OTA1.12.17)
ggtgtgggtggcgtaaagggagcatcgg

SEQ ID NO: 18 - DNA, 15 bp, Artificial Sequence
  Synthetic DNA ligand (ARC183)
ggttggtgtggttgg

SEQ ID NO: 19 - DNA, 72 bp, Artificial Sequence
  Synthetic DNA ligand (OTA1.12.2-2X)
gatcgggtgtgggtggcgtaaagggagcatcggacagatcgggtgtgggtggcgtaaagggagcatcggaca

SEQ ID NO: 20 - DNA, 61 bp, Artificial Sequence
  Synthetic DNA ligand (OTA1.12.2)
tggtggctgtaggtcagcatctgatcgggtgtgggtggcgtaaagggagcatcggacaacg